(19) United States
(12) Patent Application Publication
(10) Pub. No.: US 2020/0334603 A1
(43) Pub. Date: Oct. 22, 2020

(54) SYSTEMS AND METHODS FOR AUTOMATED PROVIDER RATIONALIZATION USING MACHINE LEARNING-ASSISTED AND ADVANCED ANALYTICS TECHNIQUES

(71) Applicant: Verizon Patent and Licensing Inc., Arlington, VA (US)

(72) Inventors: Hossein Abdollahnejadbarough, New Brunswick, NJ (US); Kalyan Sashank Mupparaju, Stirling, NJ (US)

(21) Appl. No.: 16/388,816

(22) Filed: Apr. 18, 2019

(51) Int. Cl. G06Q 10/06; G06F 16/904; G06K 9/62; G06N 20/00; G06F 17/27

(52) U.S. Cl. CPC G06Q 10/06315; G06F 16/904; G06F 17/27; G06N 20/00; G06K 9/6223

(57) ABSTRACT

A system described herein may use automated techniques, such as machine learning techniques and/or deep learning, to identify providers for an organization who are at the tail of the company's sourcing utilization. The system may cluster the providers based on types of business attributes, such that similar providers are compared to each other, and score the providers on a per-cluster basis. The system may further rank the providers on a per-cluster basis to identify replacement candidates, and utilize optimization techniques to automatically replace the lowest ranking providers. Advanced visualizations may be generated to indicate the ranked and/or replaced providers. The system may further automatically replace tail providers in sourcing requests when identified as replaceable.

### BACKGROUND

Organizations, such as companies, often need to source goods or services from external entities that offer goods or services (i.e., “providers”). Large organizations may engage a plethora of providers for many reasons, including price, source diversification, short-term or long-term requirements, and/or other reasons. While managing relatively few of the larger providers (e.g., providers that are at the “head” of the utilization graph) can be done manually (e.g., by dedicated sourcing managers), manually managing numerous (e.g., hundreds or thousands) of smaller providers (e.g., providers that are at the “tail” of the utilization graph) may be costly or impossible to implement.

### BRIEF DESCRIPTION OF THE DRAWINGS

FIGS. 1A and 1B illustrate an example embodiment described herein, in which different types of providers for an organization may be scored, and candidates for replacement identified and replaced;

FIG. 2 illustrates an example environment in which one or more embodiments, described herein, may be implemented;

FIG. 3 illustrates an example process by which different types of providers for an organization may be scored, and candidates for replacement identified;

FIG. 4 illustrates an example process by which providers, which are candidates for replacement, may be evaluated and replaced;

FIGS. 5 and 6 illustrate example graphs that demonstrate the reduction or elimination of tail providers in accordance with performing techniques described herein; and

FIG. 7 illustrates example components of one or more devices, according to one or more embodiments described herein.

### DETAILED DESCRIPTION OF THE PREFERRED EMBODIMENTS

The following detailed description refers to the accompanying drawings. The same reference numbers in different drawings may identify the same or similar elements.

Embodiments described herein may provide for a system that utilizes machine learning and other automated techniques to identify providers for an organization to replace with other providers of similar goods or services. In some embodiments, providers at the “tail” of the usage allocation of the organization (e.g., providers that account for a relatively small portion of the sourcing usage of the organization, compared to other providers and/or compared to the overall sourcing activity of the organization) may be identified. Further, as described herein, one or more such tail providers may be replaced by other providers (e.g., providers at the “head” of the sourcing usage allocation for the organization, and/or other providers). That is, some or all of the goods or services, sourced by the organization from a given tail provider, may be instead sourced from another provider. The embodiments described herein are able to make such identifications for similar goods and/or services such that the overall operational impact to the organization may be minimal (as equivalent goods and/or services are sourced), while providing the benefit of reducing the overall number of providers that must be managed by the organization (e.g., through provider management systems and human resources).

The embodiments described herein enable capabilities heretofore not available in the context of provider management. As further described below, the automated techniques described herein are able to identify replaceable tail providers of goods and/or services in a manner not previously attainable by manual means, by applying a novel combination of analysis techniques, utilizing a diverse set of data sources, and automating provider replacement operations. The embodiments described herein may be applicable to providers of many types, including, for example, providers of physical goods, providers of physical services and providers of computing services such as cloud-based infrastructure and application programming interface (API) service providers.

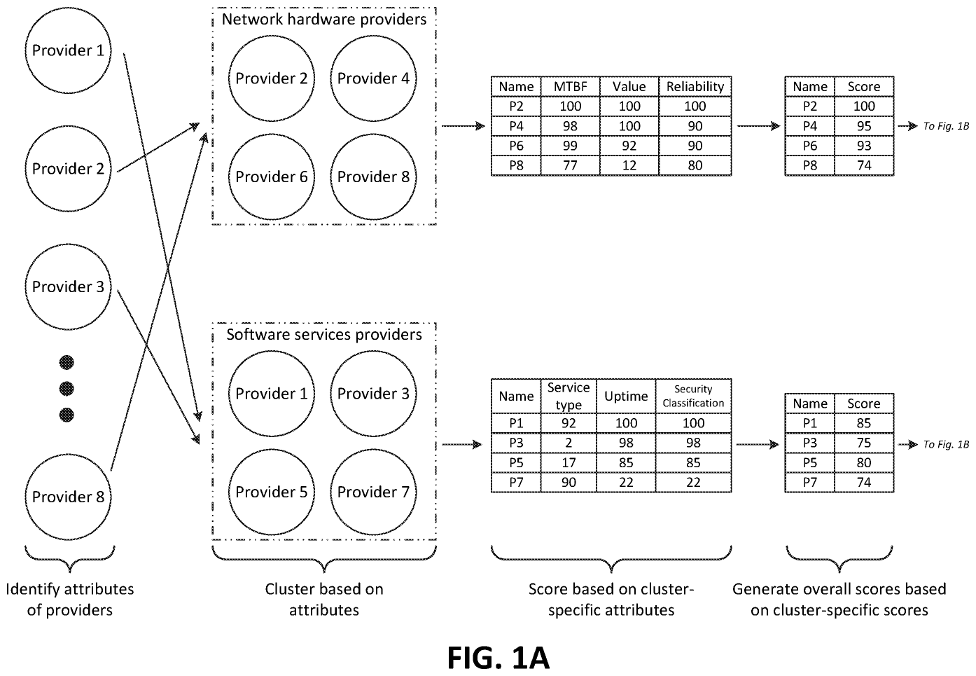

FIG. 1A conceptually illustrates a process that may be performed by a machine learning provider selection system (“MLPSS”), in accordance with some embodiments. As shown, the MLPSS may identify attributes of a set of providers (e.g., Providers 1-8, as referred to in this example) for an organization. While this example is described in the context of eight providers, similar concepts may be applied to larger sets of providers, such as hundreds or thousands of providers. MLPSS may use machine learning techniques, natural language processing (“NLP”) techniques, deep learning, neural networks, and/or other types of techniques to analyze data associated with the providers, and to identify attributes associated with the providers. The data to analyze may include “internal” data (e.g., data that is under the possession or control of the organization, such as internal usage databases, transcripts of sales or support conversations (e.g., voice-based and/or text-based conversations), and/or other proprietary information sources), and/or “external” data (e.g., data that is publicly available and/or is otherwise available from another organization). In some embodiments, the internal data, the external data, and/or both may include unstructured data (e.g., data that does not conform to a given pre-defined format or structure).

The identified attributes may include any identifiable and/or relevant attributes that are indicated by, and/or may be inferred from, the internal and/or external data. For example, attributes of a given provider may include identifiers of goods or services sourced by the organization from the provider (e.g., stock keeping units (“SKUs”)), prices of goods or services sourced by the organization from the provider, order delivery or turnaround times of the provider, service agreements between the organization and the provider (e.g., which may specify objective parameters or thresholds that should be met by the provider), and/or other types of attributes. The MLPSS may use text parsing, image recognition, and/or some other automated technique to analyze the internal and/or external data to identify words or phrases in the data, tokenize the words, convert the tokens into sequences of one-hot vectors, and identifies relationships between the words in order to identify attributes that may be relevant in evaluating or scoring the providers. Generally speaking, commonly used “hot” (or “key”) words or phrases, in the internal and/or external data, may be identified as attributes of the providers.

As further shown in FIG. 1A, the MLPSS may cluster providers into different clusters (which may be referred to as “categories” or “types” of providers) based on the identified attributes. In some embodiments, the MLPSS may use mixed principal component analysis (“MCPA”), K-means clustering, unsupervised machine learning, and/or some other suitable technique to cluster the providers. For example, one set of providers (e.g., Providers 2, 4, 6, and 8, as shown in FIG. 1A) may be identified as having attributes associated with a “network hardware provider” type. For instance, these providers may be associated with words or phrases that indicate attributes of network hardware or network hardware, such as mean time between failure (“MTBF”), value of network hardware (e.g., perceived and/or actual performance compared to price), reliability, and/or other relevant attributes. As another example, another set of providers (e.g., Providers 1, 3, 5, and 7, as shown in FIG. 1A) may be identified as having attributes associated with a “software services provider” type. For instance, these providers may be associated with words or phrases that indicate attributes of software services, such as a service type, service uptime, security classification, and/or other relevant attributes.

As additionally shown in FIG. 1A, the MLPSS may assign a score, for each provider, for the each of the identified attributes. For instance, Providers 2, 4, 6, and 8 (shown in FIG. 1A as “V2,” “V4,” “V6,” and “V8,” respectively) may each be assigned a score for “MTBF,” “value,” and “reliability” attributes, while Providers 1, 3, 5, and 7 may each be assigned a score for the “service uptime” and “security classification” attributes. In some embodiments, the scores may be normalized (e.g., on a scale of 1-100), such that disparate types of information can be represented on a similar scale. For example, while Provider 2 may be associated with a score of 100 for the MTBF attribute, the actual MTBF of products from Provider 2 may be a value other than 100. That is, the score of 100 may indicate that the MTBF of products from Provider 2 is relatively the highest out of all candidate providers. In some embodiments, the MLPSS may use data envelopment analysis (e.g., with inverse input/output) to generate the normalized scores.

As further shown in FIG. 1A, the MLPSS may generate an overall score for each provider based on the scores for the attributes. In some embodiments, the MLPSS may use Technique for Order of Preference by Similarity to Ideal Solution (“TOPSIS”), Shannon Entropy, and/or other techniques when generating the overall score for each provider. As shown in FIG. 1B, and as described below in further detail, the MLPSS may apply conditional weights, which may be used to modify scores based on specific criteria or conditions. For example, one conditional weight for “network hardware” providers may specify that if a particular provider has a delivery time of greater than 45 days, the provider's score should be reduced to 0. This conditional weight may reflect a hard constraint that no matter what other merits the provider has, the provider must be able to deliver products within 45 days in order to be maintained as a provider for the organization. As another example, for the “software services” cluster, a particular provider may have its score increased (e.g., multiplied by 1.1) if the quantity of different service types exceeds three different service types.

As further shown in FIG. 1B, the MLPSS may rank the providers based on the overall scores (e.g., after applying conditional weights). In some embodiments, the MLPSS may remove the lowest ranking providers, and/or may identify the lowest ranking providers as candidates for removal. Additionally, or alternatively, the MLPSS may remove providers that do not satisfy a minimum threshold score.

Additionally, the MLPSS may simulate, estimate, and/or otherwise determine new scores for the existing providers (e.g., the providers that were not removed, or identified as candidates for removal) based on the existing providers replacing the removed providers. For example, the MLPSS may determine the new scores for the existing providers in scenarios where goods or services, that were sourced from (and/or that will be sourced from, or are projected to be sourced from) some or all of the removed providers, are instead sourced from one or more of the existing providers. As described below, the MLPSS may identify an optimal replacement scenario that maximizes the scores of the existing providers after replacing the removed providers. In some embodiments, the MLPSS may automatically adjust sourcing requests from the existing providers in accordance with the determined optimal replacement scenarios. For example, the MLPSS may implement one or more application programming interfaces (“APIs”) via which the MLPSS may programmatically modify the sourcing requests, such that manual intervention (e.g., from a human operator) is not necessary to modify the sourcing requests. Additionally, or alternatively, the MLPSS may prepare recommendations for modifying sourcing requests, present the recommendations via one or more messages, and programmatically modify the sourcing requests after receiving approval or confirmation from an administrator or other operator.

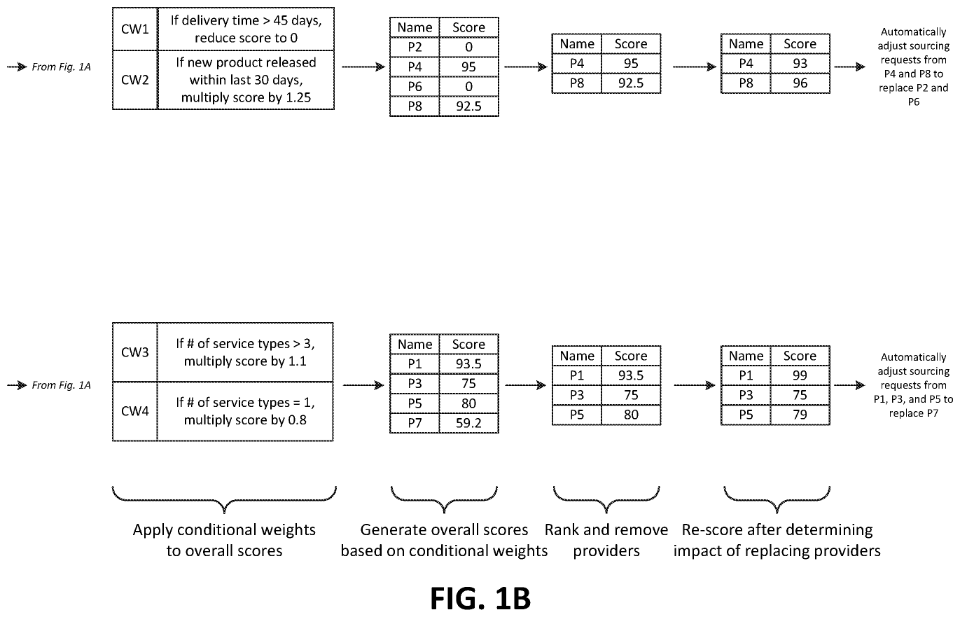

FIG. 2 illustrates an example environment 200, in which one or more embodiments, described herein, may be implemented. As shown in FIG. 2, environment 200 may include user equipment (“UE”) 205, MLPSS 210, provider information repository 215, and network 220. The quantity of devices and/or networks, illustrated in FIG. 2, is provided for explanatory purposes only. In practice, environment 200 may include additional devices and/or networks; fewer devices and/or networks; different devices and/or networks; or differently arranged devices and/or networks than illustrated in FIG. 2. For example, while not shown, environment 200 may include devices that facilitate or enable communication between various components shown in environment 200, such as routers, modems, gateways, switches, hubs, etc. Alternatively, or additionally, one or more of the devices of environment 200 may perform one or more functions described as being performed by another one or more of the devices of environments 200. Devices of environment 200 may interconnect with each other and/or other devices via wired connections, wireless connections, or a combination of wired and wireless connections. In some implementations, one or more devices of environment 200 may be physically integrated in, and/or may be physically attached to, one or more other devices of environment 200.

UE 205 may include any computation and communication device that is capable of communicating with one or more networks (e.g., network 220). For example, UE 205 may include a device that receives content, such as web pages (e.g., that include text content and/or image content), streaming audio and/or video content, and/or other content, via an Internet connection and/or via some other delivery technique. UE 205 may also receive user interactions (e.g., voice input, touches on a touchscreen, “clicks” via an input device such as a mouse, etc.). In some implementations, UE 205 may be, or may include, a radiotelephone, a personal communications system (“PCS”) terminal (e.g., a device that combines a cellular radiotelephone with data processing and data communications capabilities), a personal digital assistant (“PDA”) (e.g., a device that includes a radiotelephone, a pager, etc.), a smart phone, a laptop computer, a tablet computer, a camera, a television, a personal gaming system, a wearable device, and/or another type of computation and communication device.

MLPSS 210 may include one or more devices (e.g., a server device or a distributed set of devices, such as a cloud computing system) that perform one or more actions described herein. For example, MLPSS 210 may receive information regarding providers for an organization (e.g., from provider information repository 215 and/or some other source), may use machine learning and/or other programmatic techniques to assign the providers to categories, may score the providers using category-specific scoring, and replace one or more providers to reduce the tail spend for the organization. MLPSS 210 may, in some embodiments, report results of the scoring and/or replacing via a visual representation (e.g., may generate a graphical user interface (“GUI”), or elements of a GUI) that is presented to UE 205 (e.g., via network 220).

Provider information repository 215 may include one or more devices (e.g., a server device or a distributed set of devices, such as a cloud computing system) that perform one or more actions described herein. For example, provider information repository 215 may store information regarding one or more providers for a particular organization. For example, provider information repository 215 may store, for a given provider, information indicating an amount used of products or services sourceable from the provider (e.g., a year-over-year usage), model names or numbers of products sourced or sourceable from the provider, descriptions of products sourced or sourceable from the provider, metrics of diversity of the provider, information indicating how usage associated with the provider should be internally allocated, geographical locations associated with the provider (e.g., brick-and-mortar locations and/or locations from which goods may be shipped by the provider), ratings of the provider by credit or financial firms, and/or other types of information. Provider information repository 215 may be, or may include, databases or other internal systems (e.g., systems that are not accessible outside the organization, or without approval from an administrator associated with the organization). In some embodiments, provider information repository 215 may be, or may include, public website, services, or other external systems (e.g., systems that are accessible outside the organization).

Network 220 may include one or more radio access networks (“RANs”), via which UEs 205 may access one or more other networks or devices, a core network of a wireless telecommunications network, an IP-based packet data network (“PDN”), a wide area network (“WAN”) such as the Internet, a private enterprise network, and/or one or more other networks. In some implementations, network 220 may be, include, or be in communication with a cellular network, such as a Long-Term Evolution (“LTE”) network, a Third Generation (“3G”) network, a Fourth Generation (“4G”) network, a Fifth Generation (“5G”) network, a Code Division Multiple Access (“CDMA”) network, etc. User device 505 may connect to, and/or otherwise communicate with, via network 220, data servers, application servers, other UEs 205, etc. Network 220 may be connected to, and/or otherwise in communication with, one or more other networks, such as a public switched telephone network (“PSTN”), a public land mobile network (“PLMN”), and/or another network.

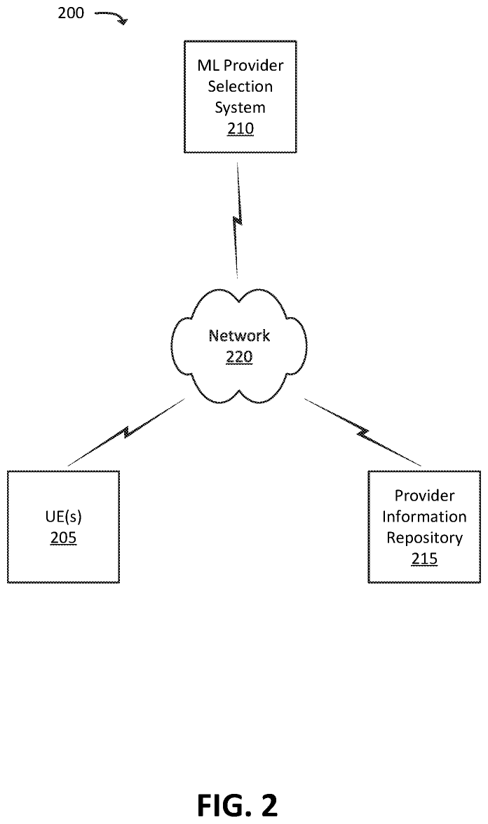

FIG. 3 illustrates an example process 300 for determining categories for providers and ranking providers within categories based on automatically identified attributes. In some embodiments, process 300 may be performed by MLPSS 210. In some embodiments, process 300 may be performed by one or more other devices in addition to, or in lieu of, MLPSS 210.

As shown, process 300 may include receiving (at 305) information regarding a set of providers for an organization. For example, MLPSS 210 may receive information from provider information repository 215 regarding providers that are associated with the organization (e.g., providers from whom the organization has sourced goods or services, and/or with whom the organization has a relationship that permits sourcing of goods and/or services). As mentioned above, provider information repository 215 may include one or more internal or external databases. The information received may include an amount of products and/or services used that are sourced from the provider (e.g., a year-over-year usage), model names or numbers of products sourced or sourceable from the provider, descriptions of products sourced or sourceable from the provider, and/or other suitable information (e.g., as enumerated above).

Process 300 may also include using (at 310) NLP and/or other automated techniques to extract provider attributes from the received information. For example, MLPSS 210 may use text parsing, image recognition, and/or some other automated technique to analyze the internal and/or external data to identify words or phrases in the data, use NLP and/or unsupervised machine learning techniques to tokenize the words, convert the tokens into sequences of one-hot vectors, and identify relationships between the words in order to identify attributes that may be relevant in evaluating or scoring the providers.

Process 300 may further include using (at 315) MCPA, K-means clustering, and/or other automated techniques to cluster (or categorize) providers. For instance, once the attributes are identified (at 310), MCPA may be used to reduce the quantity of identified attributes, by identifying differentiating and/or otherwise relevant attributes. For instance, if a relatively large number of providers share the same value for a given attribute (e.g., where one attribute may be “country,” and a relatively large number of providers are headquartered or operate in the same country), MCPA may be used to remove the attribute “country.” Once the attributes have been trimmed using MCPA, MLPSS 210 may use K-means clustering and/or some other techniques to identify providers that share the same attributes, and cluster the providers into different clusters (or categories) accordingly.

Process 300 may additionally include using (at 320) Data Envelopment Analysis (“DEA”) and/or other automated techniques to generate cluster-specific scores on a per-attribute basis for each provider. Using data envelopment analysis, one or more of the attributes, for a given provider, may be used as decision-making units to score the provider. As one example, a higher amount of usage with a provider may cause price per unit to be lower (and thus, the provider may have a higher score in a “price per unit” category). In this sense, the data envelopment analysis may be considered to have an inverse relationship between one or more inputs of the analysis and one or more outputs. In some embodiments, the data envelopment analysis may include using Formula 1.

$${D}^{g} \text{:} MIN {θ}_{{s}^{o}}^{c} - ϵ [ {\sum }_{i ∈ inputs} {Slack}_{i}^{c} + {\sum }_{o ∈ outputs} {Surplus}_{o}^{c} ] \qquad ( Formula 1 )$$

In Formula 1, g represents a cluster of providers, i represents inputs to providers (e.g., number of sourcing requests, amount used, etc.), o represents outputs from providers (e.g., amount sourced, price per unit, etc.), s^{o} represents a given provider of a set S of peer providers, ϵ is a very large positive number, and Θₛ_{⁰}^{c} represents a score of efficiency of provider s⁰ in category c. D^{g} may be evaluated on a per-cluster basis, as providers within the same cluster may share attributes while providers in different clusters may share fewer, or no attributes. Additionally, one or more constraints (represented by Formulas 2-5) may be applied.

$$\begin{matrix}{\sum }_{s ∈ S} {λ}_{s}^{c} {x}_{is}^{c} + {Slack}_{i}^{c} = {θ}_{{s}^{o}}^{c} {x}_{{is}^{o}}^{c} ∀ c , i , {s}^{o} ∉ S & ( Formula 2 ) \\ {\sum }_{s ∈ S} {λ}_{s}^{c} {y}_{os}^{c} - {Surplus}_{o}^{c} \geq {θ}_{{s}^{0}}^{c} {y}_{{os}^{o}}^{c} ∀ c , o , {s}^{o} ∉ S & ( Formula 3 ) \\ {λ}_{s}^{c} , {Surplus}_{o}^{c} , {Slack}_{i}^{c} \geq 0 ∀ s , c , o , i , s ∈ S & ( Formula 4 ) \\ 1 \geq {θ}_{{s}^{o}}^{c} \geq 0 ∀ {s}^{o} , c , {s}^{o} ∉ S & ( Formula 5 )\end{matrix}$$

In the above formulas, λₛ^{c} represents the weight of provider s in category c, xᵢₛ_{⁰}^{c} represents an amount of input (e.g., sourcing requests and/or financial resources) used by provider s⁰ in category c, and yₒₛ_{⁰}^{c} represents an amount of output (e.g., price per unit and/or other key performance indicators (“KPIs”)) generated by provider s⁰ in category c.

The constraint enforced by Formula 2 ensures that there will be no surplus of inputs to provider s^{o} compared to other providers in the same category c, while the constraint enforced by Formula 3 ensures that there will be no surplus of outputs from provider s^{o} compared to other providers in the same category c. The constraint enforced by Formulas 4 and 5 ensure that λₛ^{c}, Surplus₀^{c} and Slackᵢ^{c} are continuous, and that Θₛ_{⁰}^{c} is between 0 and 1.

Process 300 may also include using (at 325) Shannon entropy and/or other automated techniques to generate overall scores for each provider. For example, the results of determining (at 320) D^{g} (e.g., for a given cluster g) may yield a set of scores, on a per-attribute basis, for each provider in the given cluster g. However, the scores may be disparate due to, for instance, values provided for attributes that may be subjective or imprecise in nature. For example, a given provider may be assigned a relatively high subjective value for a “quality” attribute by an individual within the organization, where the relatively high subjective score may have been inflated by the individual either inadvertently or due to some bias or other reasons. Shannon entropy and/or other techniques may be employed in order to minimize variations in values for attributes that may be due to factors such as subjectivity, or other sources of imprecision or inaccuracy.

Process 300 may further include applying (at 330) conditional weights to generate modified overall scores for each provider. In some embodiments, MLPSS 210 may use TOPSIS to apply additional constraints or weights to given attributes, which may impact the overall score. For example, if an attribute for a given cluster is “lead time” (e.g., time between sourcing request and provision of a product and/or service), TOPSIS may be used to modify scores for providers that do not satisfy a given lead time (e.g., may reduce a score for the “lead time” attribute for the providers to 0, and/or may reduce the overall score for the providers to 0, etc.). In scenarios where a score for a particular attribute is modified for a given provider, the overall score for the provider may be recomputed as well to reflect the change to the score for the attribute.

Process 300 may additionally include ranking (at 335) the providers, on a per-cluster basis, based on the modified overall scores to identify replacement candidates. For example, once the overall scores for the providers have been generated (e.g., at 305-330), MLPSS 210 may rank the providers on a per-cluster basis based on the generated overall scores. In some embodiments, MLPSS 210 may generate and present a GUI that shows the ranked overall scores for providers in a given cluster, or set of clusters. In some embodiments, as discussed below, the ranking of the providers may be used in an automated process that replaces one or more providers (e.g., lowest scoring providers) with other providers (e.g., higher scoring providers).

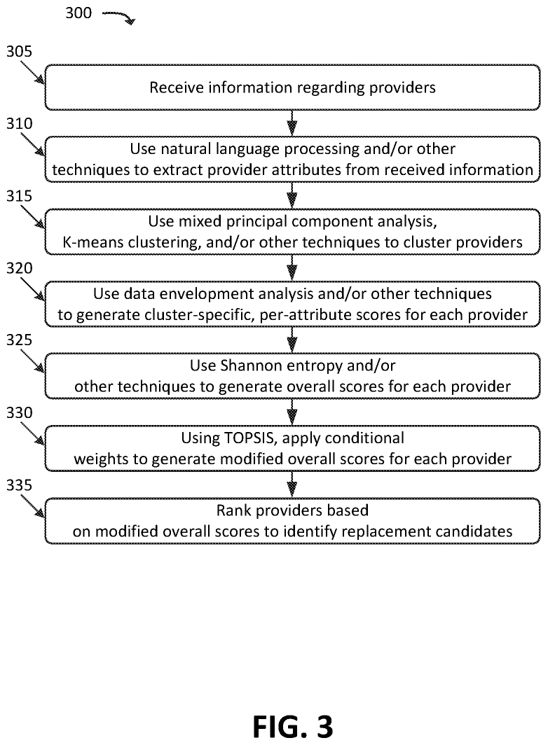

FIG. 4 illustrates process 400 for automatically adjusting sourcing requests from providers based on determining an optimal replacement scenarios for providers (e.g., providers that have been ranked in accordance with process 300, shown in FIG. 3). In some embodiments, process 400 may be performed by MLPSS 210. In some embodiments, process 400 may be performed by one or more other devices in addition to, or in lieu of, MLPSS 210.

As shown, process 400 may include identifying (at 405) goods and/or services from replacement candidate providers, including volume of sourced goods and/or services. For example, MLPSS 210 may determine (e.g., based on information received from provider information repository 215 and/or some other source) goods and/or services that have been sourced (and/or are projected to be sourced), including identifying information for products (e.g., model names or numbers), quantities of items sourced, price per unit, etc. Provider information repository 215 may determine this information, on a per-cluster basis, for replacement candidate providers (e.g., providers with the lowest scores generated in accordance with process 300) and/or for other providers (e.g., the remaining providers in a given cluster).

Process 400 may also include re-scoring (at 410) other providers based on a simulation of replacing sourced units from a given replacement candidate provider with sourced units from one or more other providers. For example, MLPSS 210 may simulate a shifting of some or all sourcing requests (e.g., past sourcing requests and/or projected sourcing requests) to one or more other providers that offer similar or the same goods and/or services as a given replacement candidate provider (e.g., providers in the same cluster as the replacement candidate), and then may re-score the one or more other providers (e.g., using the scoring techniques discussed above with respect to process 300) based on the simulated shifted sourcing requests. In some embodiments, simulating the sourced unit replacement may include determining a baseline sourcing cost per sourced unit that takes into account variances in sourcing cost that may occur (e.g., on a seasonal, annual, or other basis). In some embodiments, simulating the sourced unit replacement may include simulating the impact only of units that have a sourcing cost that is within a threshold variance, or coefficient of variance (“CV”) of, for example, 10%, 40%, or some other suitable threshold.

MLPSS 210 may, in some embodiments, perform the simulation in multiple iterations, where each iteration is referred to as a “replacement scenario.” For instance, assume that Provider 1 is a replacement candidate, and the organization sources 100 units a year from Provider A at Price P per unit (for a total amount used of 100*P). A first replacement scenario may entail the 100 units being sourced from Provider B instead of Provider A, a second replacement scenario may entail the 100 units being sourced from Provider C instead of Provider A, and a third replacement scenario may entail some portion of the units (e.g., 40 units) being sourced from Provider B and another portion (e.g., 60 units) being sourced from Provider C.

Process 400 may additionally include identifying (at 415) an optimal replacement scenario. For example, MLPSS 210 may determine, after simulating the replacement of sourcing requests from one or more replacement candidates with one or more other providers, MLPSS 210 may determine an optimal replacement scenario. The optimal replacement scenario may be the replacement scenario that results in the lowest overall cost, the highest resulting scores for the remaining providers, the lowest price per unit, and/or meets some other optimization criteria.

Process 400 may further include automatically adjusting (at 420) sourcing requests based on the optimal replacement scenario. For example, MLPSS 210 may programmatically adjust future sourcing requests to be in line with the identified optimal replacement scenario. Referring to the earlier example, assume that the optimal replacement scenario is some portion of the units (e.g., 40 units) being sourced from Provider B and another portion (e.g., 60 units) being sourced from Provider C. MLPSS 210 may adjust sourcing requests such that 40 units (e.g., 40 additional units, on top of existing sourcing requests) are sourced from Provider C, and such that 60 units (e.g., 60 additional units, on top of existing sourcing requests) are sourced from Provider C. MLPSS 210 may also adjust sourcing requests such that 0 units (e.g., instead of 100 units) are sourced from Provider A.

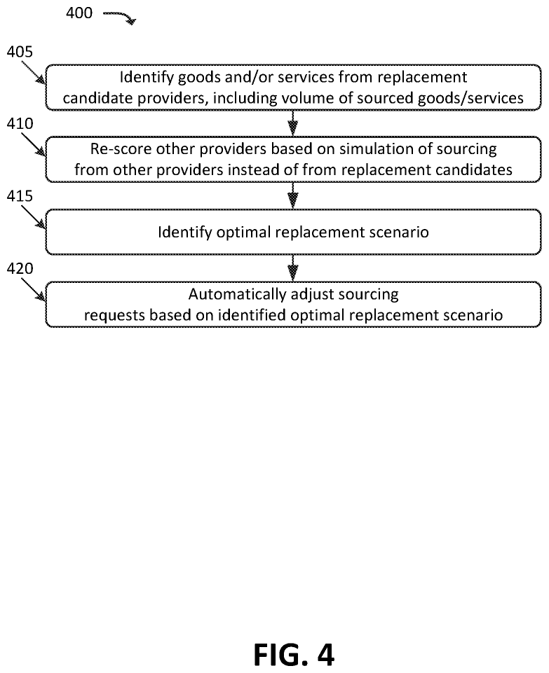

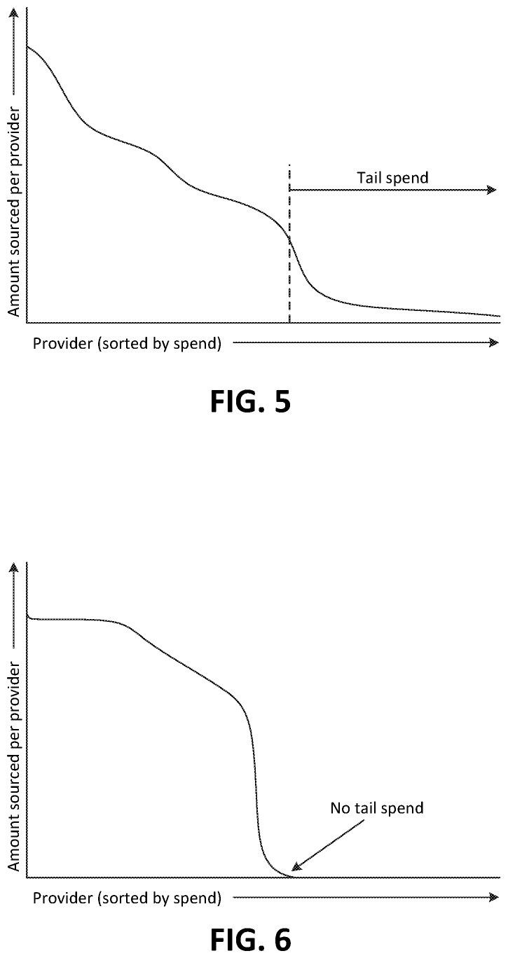

Utilizing the techniques described above (e.g., with respect to processes 300 and/or 400), the tail providers for the organization may be reduced or eliminated, resulting in concentration of sourcing activity with the head providers. For example, as shown in FIG. 5, prior to the adjustment of sourcing requests (e.g., at block 420 of FIG. 4), the sourcing utilization graph for the organization may be significantly spread among tail providers, with nearly half of the providers accounting for only a relatively small volume of the total sourcing activity for the organization. After adjustment, as shown in FIG. 6, the tail of the sourcing utilization may be reduced or eliminated. For instance, assuming that total usage of a given provider is an attribute based on which the providers are scored, providers with whom the organization consumes less volume may be identified as replacement candidates, and automatically replaced, thus eliminating the utilization graph tail.

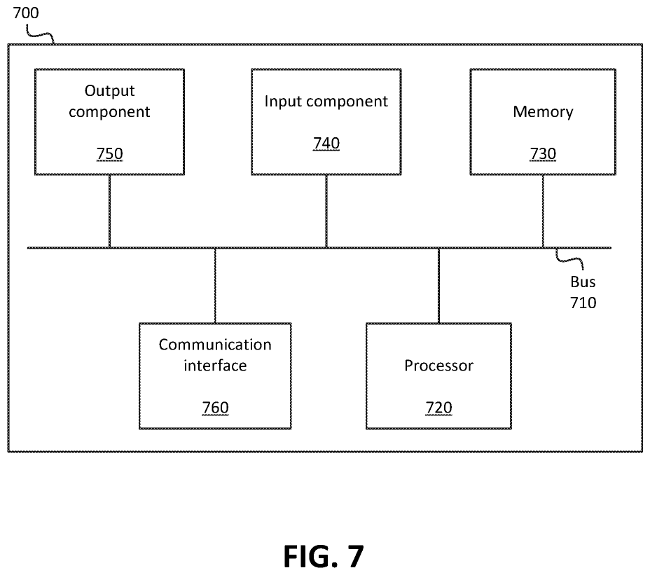

FIG. 7 illustrates example components of device 700. One or more of the devices described above may include one or more devices 700. Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, or processing logic that may interpret and execute instructions. Memory 730 may include any type of dynamic storage device that may store information and instructions for execution by processor 720, and/or any type of non-volatile storage device that may store information for use by processor 720.

Input component 740 may include a mechanism that permits an operator to input information to device 700, such as a keyboard, a keypad, a button, a switch, etc. Output component 750 may include a mechanism that outputs information to the operator, such as a display, a speaker, one or more light emitting diodes (“LEDs”), etc.

Communication interface 760 may include any transceiver-like mechanism that enables device 700 to communicate with other devices and/or systems. For example, communication interface 760 may include an Ethernet interface, an optical interface, a coaxial interface, or the like. Communication interface 760 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 700 may include more than one communication interface 760. For instance, device 700 may include an optical interface and an Ethernet interface.

Device 700 may perform certain operations relating to one or more processes described above. Device 700 may perform these operations in response to processor 720 executing software instructions stored in a computer-readable medium, such as memory 730. A computer-readable medium may be defined as a non-transitory memory device. A memory device may include space within a single physical memory device or spread across multiple physical memory devices. The software instructions may be read into memory 730 from another computer-readable medium or from another device. The software instructions stored in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description but is not intended to be exhaustive or to limit the possible implementations to the precise form disclosed. Modifications and variations are possible in light of the above disclosure or may be acquired from practice of the implementations.

For example, while series of blocks have been described with regard to FIGS. 3 and 4, the order of the blocks may be modified in other implementations. Further, non-dependent blocks may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

To the extent the aforementioned implementations collect, store, or employ personal information provided by individuals, it should be understood that such information shall be collected, stored, and used in accordance with all applicable laws concerning protection of personal information. Additionally, the collection, storage, and use of such information may be subject to consent of the individual to such activity (for example, through “opt-in” or “opt-out” processes, as may be appropriate for the situation and type of information). Storage and use of personal information may be in an appropriately secure manner reflective of the type of information, for example, through various encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
a non-transitory computer-readable medium storing a set of processor-executable instructions; and
one or more processors configured to execute the set of processor-executable instructions, wherein executing the set of processor-executable instructions causes the one or more processors to:
receive information regarding a plurality of providers for an organization;
extract, from the information, a plurality of attributes of the plurality of providers;
cluster, based on the attributes of the plurality of providers, the plurality of providers into a plurality of clusters,
wherein a first cluster, of the plurality of clusters, includes a first set of providers, of the plurality of providers, wherein the first set of providers are each associated with a first set of attributes that each have a respective value for each provider of the first set of providers, and
wherein a second cluster, of the plurality of clusters, includes a second set of providers, of the plurality of providers, that is different from the first set of providers, wherein the second set of providers are each associated with a second set of attributes that each have a respective value for each provider of the second set of providers, wherein the first and second sets of attributes are different;
generate, for the first cluster, a first set of scores for each provider of the first set of providers, wherein each score, of the first set of scores, is associated with a particular attribute of the first set of attributes;
generate, for the second cluster, a second set of scores for each provider of the second set of providers, wherein each score, of the second set of scores, is associated with a particular attribute of the second set of attributes;
generate, for the first cluster and based on the first set of scores associated with each provider of the first set of providers, a respective overall score for each provider of the first set of providers;
generate, for the second cluster and based on the second set of scores associated with each provider of the second set of providers, a respective overall score for each provider of the second set of providers;
rank, for the first cluster, the first set of providers based on the respective overall scores for the first set of providers;
rank, for the second cluster, the second set of providers based on the respective overall scores for the second set of providers;
select, based on the ranking for the first cluster, one or more providers, of the first set of providers, to replace;
select, based on the ranking for the second cluster, one or more providers, of the second set of providers, to replace;
automatically replace the selected one or more providers, of the first set of providers, with another provider, of the first set of providers, in a first sourcing request for goods or services, previously associated with the selected one or more providers, of the first set of providers, from the other provider, of the first set of providers; and
automatically replace the selected one or more providers, of the second set of providers, with another provider, of the second set of providers, in a second sourcing request for goods or services, previously associated with the selected one or more providers, of the second set of providers, from the other provider, of the second set of providers.

2. The device of claim 1, wherein executing the processor-executable instructions, to extract the plurality of attributes from the information regarding the plurality of providers, causes the one or more processors to use at least one of:
machine learning techniques,
natural language processing techniques, or
neural networks.

3. The device of claim 1, wherein executing the processor-executable instructions, to cluster the plurality of providers into the plurality of clusters, causes the one or more processors to use at least one of:
mixed principal component analysis, or
K-means clustering.

4. The device of claim 1, wherein executing the processor-executable instructions, to generate the first set of scores for the first set of providers, causes the one or more processors to use data envelopment analysis.

5. The device of claim 1, wherein executing the processor-executable instructions, to generate the respective overall scores for each provider of the first set of providers, causes the one or more processors to use at least one of:
Shannon entropy, or
Technique for Order of Preference by Similarity to Ideal Solution.

6. The device of claim 1, wherein executing the processor-executable instructions, to select one or more providers, of the first set of providers, to replace, causes the one or more processors to:
identify a plurality of replacement scenarios, wherein different replacement scenarios include shifting different amounts of sourced goods or services, previously associated with the selected one or more providers of the first set of providers, to different combinations of the other providers, of the first set of providers.

7. The device of claim 6, wherein executing the processor-executable instructions, to select one or more providers, of the first set of providers, to replace, further causes the one or more processors to:
identify a particular optimal replacement scenario, out of the plurality of replacement scenarios, wherein the optimal replacement scenario includes shifting sourced goods or services, previously associated with the selected one or more providers of the first set of providers, to the other provider of the first set of providers.

8. A non-transitory computer-readable medium, storing a set of processor-executable instructions, which, when executed by one or more processors, cause the one or more processors to:
receive information regarding a plurality of providers for an organization;
extract, from the information, a plurality of attributes of the plurality of providers;
cluster, based on the attributes of the plurality of providers, the plurality of providers into a plurality of clusters,
wherein a first cluster, of the plurality of clusters, includes a first set of providers, of the plurality of providers, wherein the first set of providers are each associated with a first set of attributes that each have a respective value for each provider of the first set of providers, and
wherein a second cluster, of the plurality of clusters, includes a second set of providers, of the plurality of providers, that is different from the first set of providers, wherein the second set of providers are each associated with a second set of attributes that each have a respective value for each provider of the second set of providers, wherein the first and second sets of attributes are different;
generate, for the first cluster, a first set of scores for each provider of the first set of providers, wherein each score, of the first set of scores, is associated with a particular attribute of the first set of attributes;
generate, for the second cluster, a second set of scores for each provider of the second set of providers, wherein each score, of the second set of scores, is associated with a particular attribute of the second set of attributes;
generate, for the first cluster and based on the first set of scores associated with each provider of the first set of providers, a respective overall score for each provider of the first set of providers;
generate, for the second cluster and based on the second set of scores associated with each provider of the second set of providers, a respective overall score for each provider of the second set of providers;
rank, for the first cluster, the first set of providers based on the respective overall scores for the first set of providers;
rank, for the second cluster, the second set of providers based on the respective overall scores for the second set of providers;
select, based on the ranking for the first cluster, one or more providers, of the first set of providers, to replace;
select, based on the ranking for the second cluster, one or more providers, of the second set of providers, to replace;
automatically replace the selected one or more providers, of the first set of providers, with another provider, of the first set of providers, in a first sourcing request for goods or services, previously associated with the selected one or more providers, of the first set of providers, from the other provider, of the first set of providers; and
automatically replace the selected one or more providers, of the second set of providers, with another provider, of the second set of providers, in a second sourcing request for goods or services, previously associated with the selected one or more providers, of the second set of providers, from the other provider, of the second set of providers.

9. The non-transitory computer-readable medium of claim 8, wherein the processor-executable instructions, to extract the plurality of attributes from the information regarding the plurality of providers, include processor-executable instructions to use at least one of:
machine learning techniques,
natural language processing techniques, or
neural networks.

10. The non-transitory computer-readable medium of claim 8, wherein the processor-executable instructions, to cluster the plurality of providers into the plurality of clusters, include processor-executable instructions to use at least one of:
mixed principal component analysis, or
K-means clustering.

11. The non-transitory computer-readable medium of claim 8, wherein the processor-executable instructions, to generate the first set of scores for the first set of providers, include processor-executable instructions to use data envelopment analysis.

12. The non-transitory computer-readable medium of claim 8, wherein the processor-executable instructions, to generate the respective overall scores for each provider of the first set of providers, include processor-executable instructions to use at least one of:
Shannon entropy, or
Technique for Order of Preference by Similarity to Ideal Solution.

13. The non-transitory computer-readable medium of claim 8, wherein the processor-executable instructions, to select one or more providers, of the first set of providers, to replace, include processor-executable instructions to:
identify a plurality of replacement scenarios, wherein different replacement scenarios include shifting different amounts of sourced goods or services, previously associated with the selected one or more providers of the first set of providers, to different combinations of the other providers, of the first set of providers.

14. The non-transitory computer-readable medium of claim 13, wherein the processor-executable instructions, to select one or more providers, of the first set of providers, to replace, include processor-executable instructions to:
identify a particular optimal replacement scenario, out of the plurality of replacement scenarios, wherein the optimal replacement scenario includes shifting sourced goods or services, previously associated with the selected one or more providers of the first set of providers, to the other provider of the first set of providers.

15. A method, comprising:
receiving, by one or more processors of a device, information regarding a plurality of providers for an organization;
extracting, by one or more processors of a device, from the information, a plurality of attributes of the plurality of providers;
clustering, by one or more processors of a device, based on the attributes of the plurality of providers, the plurality of providers into a plurality of clusters,
wherein a first cluster, of the plurality of clusters, includes a first set of providers, of the plurality of providers, wherein the first set of providers are each associated with a first set of attributes that each have a respective value for each provider of the first set of providers, and
wherein a second cluster, of the plurality of clusters, includes a second set of providers, of the plurality of providers, that is different from the first set of providers, wherein the second set of providers are each associated with a second set of attributes that each have a respective value for each provider of the second set of providers, wherein the first and second sets of attributes are different;
generating, by one or more processors of a device, for the first cluster, a first set of scores for each provider of the first set of providers, wherein each score, of the first set of scores, is associated with a particular attribute of the first set of attributes;
generating, by one or more processors of a device, for the second cluster, a second set of scores for each provider of the second set of providers, wherein each score, of the second set of scores, is associated with a particular attribute of the second set of attributes;
generating, by one or more processors of a device, for the first cluster and based on the first set of scores associated with each provider of the first set of providers, a respective overall score for each provider of the first set of providers;
generating, by one or more processors of a device, for the second cluster and based on the second set of scores associated with each provider of the second set of providers, a respective overall score for each provider of the second set of providers;
ranking, by one or more processors of a device, for the first cluster, the first set of providers based on the respective overall scores for the first set of providers;
ranking, by one or more processors of a device, for the second cluster, the second set of providers based on the respective overall scores for the second set of providers;
selecting, by one or more processors of a device, based on the ranking for the first cluster, one or more providers, of the first set of providers, to replace;
selecting, by one or more processors of a device, based on the ranking for the second cluster, one or more providers, of the second set of providers, to replace;
automatically replacing, by one or more processors of a device, the selected one or more providers, of the first set of providers, with another provider, of the first set of providers, in a first sourcing request for goods or services, previously associated with the selected one or more providers, of the first set of providers, from the other provider, of the first set of providers; and
automatically replacing, by one or more processors of a device, the selected one or more providers, of the second set of providers, with another provider, of the second set of providers, in a second sourcing request for goods or services, previously associated with the selected one or more providers, of the second set of providers, from the other provider, of the second set of providers.

16. The method of claim 15, extracting the plurality of attributes from the information regarding the plurality of providers, includes using at least one of:
machine learning techniques,
natural language processing techniques, or
neural networks.

17. The method of claim 15, wherein clustering the plurality of providers into the plurality of clusters, includes using at least one of:
mixed principal component analysis, or
K-means clustering.

18. The method of claim 15, wherein generating the first set of scores for the first set of providers, includes using data envelopment analysis.

19. The method of claim 15, wherein generating the respective overall scores for each provider of the first set of providers, includes using at least one of:
Shannon entropy, or
Technique for Order of Preference by Similarity to Ideal Solution.

20. The method of claim 15, wherein selecting one or more providers, of the first set of providers, to replace, includes:
identifying a plurality of replacement scenarios, wherein different replacement scenarios include shifting different amounts of sourced goods or services, previously associated with the selected one or more providers of the first set of providers, to different combinations of the other providers, of the first set of providers.
